(19) United States
(12) Patent Application Publication
(10) Pub. No.: US 2009/0311376 A1
(43) Pub. Date: Dec. 17, 2009

(54) METHOD OF PRODUCING MODIFIED WHOLE GRAIN OAT FLOUR AND PRODUCTS CONTAINING MODIFIED WHOLE GRAIN OAT FLOUR

(75) Inventors: Chigurupati Sambasiva Rao, Omaha, NE (US); William Aubrey Bonner, Kansas City, MO (US); K. Michael King, (US)

Correspondence Address: POLSINELLI SHUGHART PC, 700 W. 47TH STREET, SUITE 1000, KANSAS CITY, MO, 64112-1802, US

(73) Assignee: 21st Century Grain Processing, Kansas City, MO (US)

(21) Appl. No.: 12/352,918

(22) Filed: Jan. 13, 2009

Related U.S. Application Data
(60) Provisional application No. 61/060,588, filed on Jun. 11, 2008.

(51) Int. Cl. A23L 1/10

(52) U.S. Cl. 426/28

(57) ABSTRACT

A method of producing modified whole grain oat flour that includes the digestion of oat fiber using fiber-digesting enzymes, is described. The resulting modified whole grain oat flour contains the whole oats, including the digested fiber, as well as the fiber-digesting enzymes. In addition, topical formulations and food products that include modified whole grain oat flour as an ingredient are described.

### CROSS REFERENCE TO RELATED APPLICATIONS

This application claims the priority of U.S. provisional application No. 61/060,588, filed Jun. 11, 2008, which is hereby incorporated by reference in its entirety.

### FIELD OF THE INVENTION

The present invention relates generally to methods of treating whole grain oat flour to produce modified whole grain oat flour, in which the macromolecular particles of the whole grain are digested using enzymes. In particular, the invention relates to products that include as an ingredient a modified whole grain oat flour with enzymatically-digested macromolecular particles for further processing and functional, nutritional, and organoleptic benefits.

### BACKGROUND

Whole oats (Avena sativa) and oat derivatives are versatile grain products that enjoy a wide variety of uses. Rolled oats and oatmeal are consumed in part due to their energy-packed flavor, as well as the numerous nutritional benefits of oats. Oats contain soluble fiber in the form of beta-glucan, a class of non-digestible polysaccharide. Whole oats also contain one of the highest lipid contents of any cereal grain. Oat oil is virtually free of trans-fatty acids, and is also rich in polar lipids and anti-oxidants. The protein content of oats is the highest among the cereal grains. Unlike many other grain cereals, which contain the storage protein gluten, the major storage protein used by oats is avenalin, a salt water-soluble globulin. The absence of gluten makes rolled oats and oatmeal an important part of the gluten-free diet required by persons suffering from severe gluten antibody mediated allergies. However, oats also contain avenin, a secondary water-insoluble storage protein. At lower levels, avenin may cause issues in a small fraction of persons suffering from celiac disease.

Oat derivatives have anti-pruritic, anti-histamine, and anti-inflammatory effects when applied to the skin. Oat oil is a powerful skin emollient with strong skin hydrating and moisturizing properties and deep anti-oxidant activity. The carbohydrates and proteins in the oat derivatives also function as protectants that enhance the skin's barrier properties and that additionally soothe the skin.

In addition to personal care products, whole oat products are used as nutritional additives in foods and beverages such as nutrition bars, smoothies, and fermented products such as yogurt. These whole oat additives are either in the form of whole oat flour, or aqueous suspensions of whole oats that include starches that been partially digested by enzymes such as amylases. As a nutritional additive, whole oat products possess many beneficial properties, including the ability to lower blood cholesterol levels and to prevent heart disease, as well as low allergenicity.

The problems associated with the utilization of whole oat products stem largely from the basic processes involved in milling whole oat flour. After de-hulling, the whole oats are steamed or otherwise heated to arrest any further intrinsic enzymatic activity, and then the whole oats are ground to a powder. The resulting powder is sorted into different particle-size groupings using sifting or other techniques. The finer powder is generally made up of ground endosperm. The coarser powder is generally made up of bran and germ particles that are particularly difficult to grind to a fine consistency. Also, the bran and germ particles impart an undesirable darker or speckled color and an uneven grainy texture to the whole oat flour.

In particular, the fiber contained in the whole oats is typically broken down via mechanical means. The resulting whole grain flour has tremendous health benefits, but the fiber (regardless of particle size) imparts a gritty mouth-feel to the whole grain oat flour. This gritty texture also affects the skin-feel of the product. As a result of the gritty texture, whole grain oat flours may be either stripped of the fiber or mechanically pulverized to a very fine particle size to yield colloidal oatmeal, for use in certain applications. Despite the very fine particle size, the colloidal oatmeal products are still hampered by poor spreadability properties. For this reason, it is desired to have whole grain oat flour with all of its components intact, possessing excellent spreadability properties, and in which the skin-feel and mouth-feel are smooth.

In addition, it is desired to have whole grain oat flour that contains all components of the whole oat, including avenin, in a form that may be safely consumed by individuals suffering from celiac disease. It is desired to have a whole grain oat flour in which the avenin proteins and any other storage proteins resulting from non-oat grain cross-contamination are enzymatically hydrolyzed, resulting in a whole oat four that may be safely eaten by individuals suffering from celiac disease and labeled “gluten-free.”

### SUMMARY OF INVENTION

The present invention describes a method of producing modified whole grain oat flour, slurry, or solution. The method of the present invention combines traditional dry milling methods, such as grinding, with other processing and wet milling methods including the enzymatic degradation of the macromolecular particles, emulsification, and further particle size reduction. The enzymatic degradation of the macromolecular particles may include, for example, the enzymatic hydrolysis of the fiber components of the whole oats.

The flour or suspended particles that result from the method of the present invention may have an average particle size of less than about 150 μm. In an embodiment, the flour or suspended particles may be less than about 44 μm, or less than about 0.4 μm in size.

Whole grain oat products possess highly desirable dermatological and nutritional properties, due to ingredients such as beta-glucan, avenalin globulin proteins, and anti-oxidants, but existing whole oat flours are notoriously grainy in texture. The ultra-fine consistency of the resulting whole grain oat flour makes it suitable as an additive to many products, described below, including personal care, food, beverage, and pharmaceutical products. Unlike existing whole grain oat flours, the modified whole grain oat flour imparts a smooth and creamy texture when added to the various described products, and leaves little residue in the case of topical skin care products. In addition, the whole grain oat products do not pose a concern to individuals suffering from celiac disease or gluten allergies.

The method of the present invention includes heating an aqueous suspension of whole oat flour at a pH ranging between about 3 and about 6, and then adding digesting enzymes to break down the various macromolecular particles of the whole oats, including the fiber components. For example, the digesting enzymes may include cellulose, protease, and amylase. The enzymatic digestion of the macromolecular components of the whole oats may be performed in two steps in order to maintain a viscosity of the mixture that is compatible with the particular equipment used in the method of the present invention. After partially or fully gelatinizing the starch components of the whole oats, the mixture is filtered, emulsified and wet milled in a homogenizer, sonolator or jet mill. After wet milling, the resulting modified whole oat product may be used in the form of an aqueous suspension. The aqueous suspension may be dried and then ground using dry milling methods, resulting in modified whole grain oat flour.

The present invention further describes a topical cream that includes either the aqueous suspension form of the modified whole grain oat product or the modified whole grain oat flour. The topical cream may be a skin or hair care product, including skin-moisturizing lotion, skin cleansing lotion, foundation, face powder, mascara, lipstick, shampoo, and hair conditioner.

The present invention further describes a whole oat-fortified food product that includes the modified whole grain oat product. In addition, the present invention describes a whole oat-fortified beverage product that includes the modified whole grain oat product. The present invention further describes a pharmaceutical formulation that includes the modified whole grain oat product.

The smooth textures of the products described herein containing the modified whole grain oat flour produced using the method described herein overcome many of the previous limitations of prior whole grain oat products and oat derivative products. In addition, the modified whole grain oat suspension or flour may be used as a gluten free food ingredient, or as a carrier or additive for pharmacological or medical nutritive formulations.

### DETAILED DESCRIPTION OF INVENTION

The present invention describes a method of treating whole grain flour, typically oat flour, resulting in modified whole grain oat flour that imparts a smooth and creamy texture when added to topical creams and food products. The average particle size of the modified whole grain oat product is less than about 150 μm. In an embodiment, the modified whole grain oat product has an average particle size of less than about 44 μm, or less than about 0.4 μm. The method includes using an enzymatic treatment, along with traditional milling, to reduce particle size.

The modified whole grain oat product is a whole grain product, defined herein as flour that includes the bran, germ, and endosperm of the grain, in contrast to refined flour that retains only the endosperm. The fiber particles of the modified whole grain oat flour, comprising non-starch polysaccharides such as cellulose, hemicellulose, lignin, and beta-glucan, are much smaller than the fiber particles typically contained in whole grain flour, so that the fiber is not readily detected in the modified whole grain oat flour. In addition, the fat level of the modified whole grain oat flour may be at least about 5% by weight. Importantly, the modified whole grain oat flour retains all of the beneficial dermatological and nutritional qualities of whole oats, due to the retention of ingredients such as oat bran, oat oil, oat proteins, beta-glucan, and anti-oxidants.

In addition, the modified whole grain oat product is a gluten free product, defined herein as a product in which persons suffering from celiac disease can safely eat. In particular, any avenin storage proteins or proteins resulting from cross-contamination by other grains in the whole oat flour are enzymatically digested with proteases, rendering the modified whole grain oat product safe for consumption by persons suffering from celiac disease.

The small particle sizes of the modified whole grain oat flour are not achieved via mechanical means, but instead utilize fiber-digesting enzymes to digest the cellulose particles contained in the whole grain oats. To digest the fiber, a cellulase enzyme is used.

The cellulase enzymes are capable of digesting the fiber content of the whole grain, including cellulose, hemicellulose, lignin, beta-glucan, and combinations thereof. The fiber-digesting enzymes used in the method of the present invention digest the fiber of the grain by catalyzing the hydrolysis of cellulose, a major component of the fiber. Cellulose is composed of D-glucose units, which condense through β(1→4)-glycosidic bonds to form crystalline structures that are connected through amorphous intertwining regions. Three different classes of cellulase enzymes degrade the cellulose into individual glucose units through a variety of chemical mechanisms. Endocellulase enzymes disrupt the crystalline structure of cellulose, resulting in the exposure of individual cellulose polysaccharide fibers to further enzymatic degradation. Exocellulase enzymes catalyze the hydrolysis of the individual cellulose fibers into smaller sugars. The smaller sugars such as disaccharides and tetrasaccharides are hydrolyzed into glucose, catalyzed by beta-glucosidase. Cellulase enzymes from any of the classes described above may be suitable for the method of the present invention, including endoglucanase, endo-1,4-beta-D-glucanase, carboxomethyl cellulase, beta-1,4-glucanase, beta-1,4-endoglucan hydrolase, cellulodextrinase, avicelase, beta-glucosidase, and combinations thereof.

In an embodiment, amylase and protease enzymes may additionally be used to digest the starch and storage protein particles, respectively, included in the whole oats. The amylase enzymes used may be selected from a wide variety of amylases known in the art, including, but not limited to, alpha-amylase, beta-amylase, and gamma-amylase. The protease enzymes used may be selected from a wide variety of proteases known in the art provided that the enzyme hydrolysis of the whole oat proteins result in a preparation that yields less than 20 ppm of avenin or other glutens. Non-limiting examples of proteases suitable for use in the method of the present invention include serine proteases, threonine proteases, cysteine proteases, aspartic acid proteases, metalloproteases, glutamic acid proteases, and combinations thereof.

In order to produce a modified whole oat flour product that meets specific particle size requirements for use in various pharmaceutical and dietary supplement products, the use of a jet mill may be desired. However, wet jet milling of cellulose may be difficult to achieve due to the non-crystalline regions of large intertwined cellulose. By using enzymatic hydrolysis of the cellulose to unravel and reduce the length of the cellulose particles, the use of a jet mill can be accomplished.

The cleaned whole oat flour that is treated using the method of the present invention may be milled using conventional methods from whole oat sources including oat grain, oat groats, oat flakes, or combinations thereof. Prior to milling, the outer hulls of the whole oats may be removed from the whole oat grain. All other parts of the oat grain are retained in the whole oat flour, including the endosperm, bran, and germ of the oats. The fat content of the cleaned whole oat flour may be at least about 5% by weight. The cleaned whole oat flour may have an average particle size distribution such that between about 55% and about 65% of the flour particles are smaller than 100 mesh (149 μm) in size, between about 10% and about 20% are between 50 mesh (297 μm) and 100 mesh (149 μm) in size, and between about 1% and about 5% are between 20 mesh (840 μm) and 35 mesh (505 μm) in size.

The method of producing the modified whole grain oat flour of the present invention includes an initial step of contacting cleaned whole oat flour in water in an amount ranging between about 0.1% and about 50% by weight, and more preferably in an amount ranging between about 10% and about 33% by weight, resulting in a suspension. The water used in the method of the present invention may include tap water, distilled water, deionized water, sterilized water, and combinations thereof. Tap water used in the method of the present invention may be treated with a variety of water treatment systems including softening systems, reverse osmosis filtration systems, carbon filtration systems, micro-filtration systems, and combinations thereof.

The pH of the suspension may then be adjusted to a value ranging between about 3 and about 6, the pH range at which cellulase enzyme is optimally activated below 50° C. In an embodiment, the pH of the suspension may be adjusted to a pH ranging between about 4.0 and about 5.5 at a temperature ranging between about 50° C. and about 65° C., or to a pH ranging between about 4.5 and about 5.0 at a temperature above about 70° C. The pH of the suspension may be adjusted by contacting the suspension with an amount of acidity-regulating food additive such as a food-grade acid. Food-grade acid, as defined herein, is an acid of sufficient purity for use as an ingredient in food products for human consumption. Non-limiting examples of food-grade acids include phosphoric acid, acetic acid, calcium acetate, lactic acid, malic acid, fumaric acid, citric acid, tartaric acid and combinations thereof. Any of a variety of molarities of food-grade acids may be used, as long as the resulting pH of the suspension falls between about 4.8 and 5.2.

At least one digestive enzyme, described above, may then be added to the suspension, causing the resulting mixture to enzymatically degrade any macromolecular particles present in the mixture. The at least one digesting enzyme may be added to the suspension in an amount ranging between about 0.5% and about 6% of the weight of the oat flour, and preferably in an amount of about 1% of the weight of the oat flour in the suspension. The suspension may be heated to a temperature ranging between about 50° and about 55° C. to enhance the efficiency of the at least one digestive enzyme, and maintained at this temperature for an amount of time ranging between about 30 minutes and about 90 minutes. The amount of time selected is sufficient for the digesting enzyme to digest at least 80% of the macromolecular particles to be digested, or to achieve an average macromolecular particle size of less than about 150 μm, less than about 44 μm, or less than about 0.4 μm in an embodiment. After the enzymatic degradation reaction has run for a desired amount of time, the suspension may be heated to a temperature ranging between about 85° C. and about 95° C., for between about 5 minutes and about 20 minutes, and more preferably for about 10 minutes. The temperature and duration of time is selected to gelatinize the starches in the suspension, and to deactivate the cellulase enzymes. The enzymes may also be deactivated by other means including raising or lowering the pH of the suspension by adding food-grade bases or acids, respectively, to the suspension. After gelatinizing the starches and deactivating the at least one digestive enzyme in the suspension, any remaining macromolecular particles may removed from the mixture by filtering the suspension through a 100 mesh screen.

The filtered suspension may then be homogenized, preferably using ultrasonic sonolators. In an ultrasonic sonolator, the suspension is forced through an orifice under high pressure into a mixing chamber. As the suspension exits the orifice at high speed, ultrasonic cavitation of the suspension occurs. In addition, the suspension leaving the orifice impinges on a fixed blade in the mixing chamber, forming vortices of cavitated suspension. The extreme acceleration through the orifice, ultrasonic cavitation, and swirling vortex movement all combine to thoroughly mix the suspension into a homogenous mixture. The filtered suspension may also be homogenized using known devices such as blade systems, blenders, rotor-stator systems, colloid mills, high-pressure extruders, hammermills, sonicators, jet mills, and combinations thereof. Any homogenization device may be used, so long as the filtered suspension is homogenized to a smooth, silky texture with a uniform distribution of the oat slurry within the suspension.

The homogenized mixture may be dried using known methods such as drum drying, freeze-drying, spray granulation, fluidized bed drying, spray drying, jet milling with a combination classifier-flash drier and combinations thereof. Once the homogenized mixture has been dried, the dried mixture may be additionally ground to an average particle size of no more than about 150 μm, no more than about 44 μm, or no more than about 0.4 μm using known milling techniques such as stone milling, hammer milling, roller milling, pin milling, and combinations thereof.

During the process of producing the modified whole grain oat flour, preservatives may be added to the suspension in an amount ranging between about 0.1% and about 2% of the weight of the oat flour to inhibit the formation of bacteria or fungus in the modified whole grain oat flour. Suitable preservatives may include potassium sorbate, calcium propionate, sodium nitrate, sodium nitrite, sulfur dioxide, sodium bisulfite, potassium hydrogen sulfite, rosemary extract and combinations thereof.

The present invention further describes a topical cream that includes the modified whole grain oat flour. The modified whole grain oat flour may be suspended in a base that may include alcohols, fats, oils, surfactants, fatty acids, silicones, humectants, moisturizers, viscosity modifiers, emulsifiers, stabilizers, coloring agents, perfumes, fragrances, and combinations thereof. The topical cream may contain an amount of modified whole grain oat flour ranging between about 0.5% and about 25% by weight, or more preferably between about 1% and about 7% by weight. The amount of modified whole grain oat flour included in a topical cream may vary depending on the intended use of the topical cream.

The topical cream of the present invention may include skin and hair care products such as skin moisturizing lotions and creams, massage lotions and creams, skin cleansing lotions and creams, face masks, cleansing scrubs, shampoos, hair conditioners, hair sprays, hair gels, and lip balms. The topical cream of the present invention may also include cosmetics products such as foundation, blush, eyeliner, mascara, face powder, lipstick, and lip gloss.

The present invention also describes whole oat-fortified food products that include modified whole grain oat flour added to food products such as yogurt, pudding, sour cream, soft cheese, and ice cream. In addition, the present invention also describes whole oat-fortified beverages that include modified whole grain oat flour added to beverages such as fruit juices and nectars and smoothies. The food and beverage products contain an amount of modified whole grain oat flour ranging between about 1% and about 30% by weight, or more preferably between about 5% and about 10% by weight. The modified whole grain oat flour enriches the nutritional content of the food product, and additionally imparts a smooth and creamy texture to the food product.

The present invention also provides modified whole grain oat flour derived ingredients for pharmaceutical and other dietary supplement products to replace or augment current tableting and other pharmaceutical ingredients.

### EXAMPLES

The following examples illustrate iterations of the invention.

### Example 1

### A Prototype Treatment Process used to Manufacture Extremely Fine Whole Oat Flour

To determine the feasibility of producing modified whole grain oat flour, the following experiment was conducted.

Four pounds of cleaned whole oat flour was added to 40 pounds of purified water at temperature of 50° C., and stirred to suspend the oat flour in the water. The purified water was prepared by treating tap water with softening, reverse osmosis, carbon filtration, and micro-filtration systems. Phosphoric acid was used to adjust the pH of the suspension to a value ranging between about 4.8 and about 5.2. While maintaining a temperature of 50° C., cellulase enzymes (Liquipanol T200, Enzyme Development Corp.) were added to the suspension, and the temperature of the suspension was maintained at 50° C. for an additional hour.

After the cellulase had reacted with the suspension for one hour, the suspension was heated to a temperature ranging between about 85° C. and about 90° C. for 30 minutes to gelatinize the starch components of the suspension. The suspension was then homogenized using an ultrasound sonolator.

The homogenized suspension was then dried using a spray drying technique. The dried suspension was subsequently re-milled to a fine powder. Analysis of the powdered suspension indicated that less than 2% of the resulting particles of the powder were larger than 150 μm in average diameter.

The results of this experiment demonstrated that the prototype milling process could be used to produce whole oat flour with an average particle size below 150 μm.

### Example 2

### Viscometric Testing Revealed that Fully Hydrated Modified Whole Grain Oat Flour Suspension Exhibited Superior Spreadability to Other Fully Hydrated Oat Suspensions

To compare the spreadability of a suspension made of the modified whole grain oat flour created in Example 1 to the spreadability of other oat suspensions, the following experiment was conducted. Three suspensions were created for viscometric testing. The first suspension contained clean whole oat flour, the feedstock of the process described in Example 1, in a fully hydrated suspension. The second suspension contained a fully hydrated suspension of the modified whole grain oat flour resulting from the process detailed in Example 1. The third suspension contained a fully hydrated commercially obtained standard colloidal oatmeal suspension.

The gel strengths of the three suspensions were measured using standard industrial measurements, in which the suspensions were allowed to settle for an extended period, then subjected to measurements of shear force at a very low shear rate. The viscosities of the three suspensions were assessed using a rotational viscometer.

Further shear testing of the three suspensions was performed in a shear stress cell using standard industry methodologies. The suspensions were placed between two circular plates and a torque of gradually increasing magnitude was applied to the top plate, transmitting shear stress to the suspension samples. The measured deformation of the suspension sample due to the applied stress was used to determine the shear modulus. The peak stress that occurred prior to the material failure, or slippage, of each suspension was also determined.

Table 1 is a summary of the results of the viscometric testing of the three suspensions. Although the modified whole grain oat flour suspension had the highest viscosity due to its significantly higher water binding capability relative to the other two suspensions, this suspension also had the lowest gel strength, shear modulus, and shear stress at failure. These measurements indicated that the suspension containing the modified whole grain oat flour yielded a suspension with superior spreadability characteristics relative to the suspensions containing clean whole oat flour or colloidal oatmeal suspensions.

TABLE 1
Summary of Viscometric Testing for Three
Fully Hydrated Oat Suspensions.

| | Gel | | Shear | Peak shear |
|---|---|---|---|---|
| Type of oat | Strength | Viscosity | modulus | stress at |
| suspension | (lb/100 ft²) | (Pa-s) | (Pa) | failure (Pa) |
| Cleaned whole | 0.494 | 22 | 13,620 | 54.48 |
| oat flour | | | | |
| Modified whole | 0.375 | 140 | 4,675 | 18.07 |
| grain oat flour | | | | |
| Standard | 0.552 | 26 | 15,545 | 62.18 |
| colloidal oatmeal | | | | |

The results of this experiment demonstrated the enhanced spreadability of a fully hydrated suspension using the modified whole grain oat flour produced using the methods described in Example 1.

### Example 3

### Batch Trials Optimized the Formulation of the Enzyme-Modified Whole Oat Slurry for Drum Drying

To optimize the formulation of the enzyme-modified whole grain oat slurry for drum drying, the following experiments were conducted. A total of four formulations were produced and tested. The batches differed according to the weight percentage of whole oat flour used, and the addition of rice flour as a thickening agent. Table 2 summarizes the combinations of ingredients used in each batch.

TABLE 2
Summary of Ingredients and Processes Used in Trial Batches of
Enzyme-Modified Oat Flours.

| Batch | Purified | Oat | | Cellu- | Potassium | Rice | Drying |
|---|---|---|---|---|---|---|---|
| # | Water | Flour | H₃PO₄ | lase | sorbate | Flour | Method |
| 1A | 20 lb. | 2 lb. | 50 ml | 9.07 g | 4.55 g | 0.16 lb. | Drum |
| 1B | 20 lb. | 2 lb. | 50 ml | 9.07 g | 4.55 g | 0.00 lb. | Spray |
| 2A | 20 lb. | 3 lb. | 75 ml | 13.6 g | 6.80 g | 0.30 lb. | Drum |
| 2B | 20 lb. | 3 lb. | 75 ml | 13.6 g | 6.80 g | 0.00 lb. | Drum |

For each of the four batches, purified water was prepared by treating tap water with softening, reverse osmosis, carbon filtration, and micro-filtration systems. The purified water was heated to 50-55° C., and then the oat flour was added and mixed with the purified water. The pH of the each batch's mixture was adjusted to 5.0±0.5 by adding 10% w/w food-grade phosphoric acid (CAS # 7664-38-2, Rhodia, Inc., Cranbury, N.J., USA). The initial pH values after mixing the oat flour and water for batches 1A and 1B were measured to be 5.98. During the one hour of heating and agitation at 50-55° C., the pH of the batches were monitored and are summarized in Table 3.

TABLE 3
pH of Oat Slurries after Addition of Phosphoric Acid.

| | Batches | Batches |
|---|---|---|
| Time (min) | 1A and 1B | 2A and 2B |
| 0 | 5.22 | — |
| 30 | 5.1 | 5.2 |
| 60 | 5.1 | 5.2 |

After adjusting the pH of each mixture, cellulase enzyme (#3-3526-000, Enzyme Development Corp.) was added in the amount of 1% of the weight of the oat flour. The oat slurry for each batch was maintained at 50°-55° C. and mildly agitated for one hour. After thirty minutes of agitation, granulated potassium sorbate was added to the slurry as a food preservative.

After the completion of the heating and agitation, rice flour was added to Batches 1A and 2A as a thickening agent. All batches were then heated to 70°-80° C. for 5-10 minutes to gelatinize the starches and to inactivate the cellulose enzyme. All batches were then filtered through a 100 mesh screen to remove any remaining fiber in the oat slurry. Each batch was then processed through a sonolator to uniformly disperse or emulsify the liquid mixtures. The sonolator operating parameters for the four batches are summarized in Table 4 below. The gauge pressure reading was higher for batches 2A and 2B than in batches 1A and 1B because these oat slurries had a higher proportion of oat solids, which increased the viscosities of the slurries.

TABLE 4
Sonolator Operating Parameters for Oat Slurries.

| | Dynamic | Pump | | |
|---|---|---|---|---|
| | Pressure | Dial | | Acoustic |
| Batch # | (psig) | Setting | RPM | Intensity |
| 1A | 600 | 510 | 213.5 | 9.0 |
| 1B | 600 | 510 | 213.5 | 9.0 |
| 2A | 725 | 510 | 213.5 | 8.0 |
| 2B | 725 | 510 | 213.5 | 8.0 |

After sonolation, batch 1B was dried using a spray dryer. The oat slurry of batch 1B atomized and formed fine and coarse powders. The resulting fine powder was collected in the side chamber and the coarse powder (heavies) settled at the bottom of the spray dryer chamber. The operating parameters used for the spray dryer are summarized in Table 5.

TABLE 5
Spray Dryer Process Operating Parameters Used for Batch 1B.

| | Liquid | | Air | Furnace | Inlet Air | Chamber |
|---|---|---|---|---|---|---|
| | Temp. | Pump | Pressure | Temp. | Temp. | Pressure |
| Nozzle | (deg F.) | Speed | (psig) | (deg. F.) | (deg. F.) | (atm) |
| Lg/ext | 178 | 1.5 | 20 | 608 | 213 | 0.1 |

Batches 1A, 2A, and 2B were also dried using a drum dryer. The slurry of batch 1A did not adhere to the dryer drum surface, due to the lower proportion of solids contained in this batch relative to the other two batches. Batches 2A and 2B formed thin dehydrated oat sheets on the dryer drum surface without any burning or scorching on the drums. The sheet thickness for batch 2A was thicker than for batch 2B, likely due to the added rice flour in batch 2A. The operating parameters used for the drum dryer are summarized in Table 6.

TABLE 6
Drum Drying Operating Parameters for Oat Slurry Batches.

| | Steam | Drum | Drum | Drum |
|---|---|---|---|---|
| | Pressure | Clearance | Speed | Speed |
| Batch # | (psig) | (mm) | Readout | (RPM) |
| 1A | 42 | 5 | 1800 | 2 |
| 2A | 42 | 5 | 1800 | 2 |
| 2B | 42 | 5 | 1800 | 2 |

The results of this experiment determined optimal formulation and process parameters for the production of enzyme-modified whole grain oat slurry for drum drying. The optimum pH for activation of the cellulase enzyme was 5.0, and was achieved through the addition of 10% w/w food-grade phosphoric acid to the oat slurry. The optimal temperature for starch gelatinization was determined to be 75° C. In order to be suitably thick for drum drying, the slurry needed to contain at least 13% oat flour by weight. Even with the addition of thickening agent, the slurry with less than 10% oat flour by weight could not be dried using the drum dryer.

### Example 4

### The Effect of Sonolation on the Shelf Stability of the Enzyme-Modified Whole Oat Slurry was Determined Using Microbial Testing

To determine the shelf stability of the enzyme-modified whole oat slurry, the following experiments were conducted. Samples of the oat slurries obtained using the methods described in Example 3 were stored for two days at room temperature. To vent any fermentation gases that formed within the sample bottles, the caps of the sample bottles were opened. After two days of storage, the surface of all slurry samples showed small white colonies of yeasts.

Oat slurry samples from batches 2A and 2B produced using the methods of Example 3 were obtained before and after sonolation. After storing the samples at room temperature for two days, the samples were stored in a cooler at a temperature of 37° F. for three months. After storage in the cooler, the samples were subjected to microbial testing. The slurry samples obtained before sonolation had plate counts of 27,000,000, and the slurry samples obtained after sonolation had plate counts of 190,000.

The results of this experiment yielded the unexpected result that sonolation reduced the proliferation of microbes in the oat slurries to less than 1% of the microbial levels observed in unsonolated slurry samples.

### Example 5

### The Protein, Fiber, and Beta-Glucan Contents of Drum Dried Enzyme-Modified Whole Oat Flakes were Determined Using Assay Techniques

To determine the nutritional content of the drum dried enzyme-modified whole oat flakes, the following experiment was conducted. A sample of the drum dried enzyme-modified whole oat flakes from batch 2B, produced as described in Example 3, were subjected to an assay to determine nutritional content. The assay determined that the drum-dried whole oat flakes from batch 2B included 14.4% protein, 3.70% dietary fiber, and 0.55% beta-glucan.

The results of this experiment determined, in part, the nutritional content of the drum dried enzyme-modified whole oat flakes.

### Example 6

### The Gelatinization of the Starches Contained in the Drum Dried Enzyme-Modified Whole Grain Oat Flakes was Analyzed Using Gel Microscopy

To determine the degree of gelatinization of the starches in the drum dried enzyme-modified whole grain oat flakes, the following experiment was conducted. A sample of the whole grain oat flakes from batch 2B produced using the methods described in Example 3 was examined using a polarized light microscope. The sample was stained with iodine solution to induce a visible color change in the starch granules. When viewed with polarized light, less than 1% of the starch present was birefringent, indicating that the remaining starch in the oat flake sample contained no intact granules.

The results of this experiment determined that the starches in the drum dried enzyme-modified whole grain oat flakes were extensively gelatinized.

### Example 7

### Cosmetic Creams Incorporating the Modified Whole Grain Oat Flour Were Prepared

To determine the feasibility of preparing cosmetic creams containing modified whole grain oat flour the following experiment was conducted. Four different cosmetic creams were prepared using the formulations summarized in Table 7. The components of the aqueous phase were weighed and suspended in water, and then heated to a temperature of 75-80° C. The components of the oleaginous phase were combined and melted by heating the components to a temperature of 70° C. The oleaginous phase was added in small proportions to the aqueous phase while continuously stirring. Rose oil was then added to the emulsion as a perfume. After all of the oleaginous phase was added to the emulsion, the emulsion was homogenized to obtain a uniformly dispersed oil in water emulsion, and then cooled to room temperature, with continuous and smooth stirring, to obtain the creams.

TABLE 7
Formulations of Cosmetic Creams (Percentages of Total Weight).

| | | | | |
|---|---|---|---|---|
| Chemical Weight % | Cream A | Cream B | Cream C | Cream D |

Oleaginous Phase

| | | | | |
|---|---|---|---|---|
| Lanolin | 5% | 5% | 5% | 5% |
| Stearyl alcohol | 4% | 4% | 4% | 4% |
| White wax | 6% | 6% | 6% | 6% |
| Emulsifying wax | 1% | 1% | 1% | 1% |
| Sorbitan monooleate | 1.25% | 1.25% | 1.25% | 1.25% |
| Almond oil | 6% | 6% | 6% | 6% |
| Rose oil | Qs | Qs | Qs | Qs |

Aqueous phase

| | | | | |
|---|---|---|---|---|
| Modified whole | 4% | 4% | 4% | 4% |
| grain oat flour | | | | |
| Sorbitol | 4% | 4% | 4% | 4% |
| Polysorbate 80 | 3% | 3% | 3% | 3% |
| Methyl paraben | 0.05% | 0.05% | 0.1% | 0.1% |
| Propyl paraben | 0.05% | 0.05% | 0.1% | 0.1% |
| Deionized/sterile | Deionized/ | Sterile/ | Deionized/ | Sterile/ |
| water | Qs | Qs | Qs | Qs |

The chemicals used in the preparation of the creams are listed in Table 8.

TABLE 8
Chemicals Used in Preparation of Creams.

| Chemical | Lot # | Manufacturer |
|---|---|---|
| Lanolin | VT0977 | Spectrum |
| Steryl alcohol | VW0165 | Spectrum |
| White wax | VE1723 | Spectrum |
| Emulsifying wax | WC0090 | Spectrum |
| Sorbitan monooleate | VJ0587 | Spectrum |
| Almond oil | VL0310 | Spectrum |
| Rose oil | PX0582 | Spectrum |
| Sorbitol | WD1328 | Spectrum |
| Polysorbate 80 (Tween 80) | WA1513 | Spectrum |
| Methyl paraben | WB0486 | Spectrum |
| Propyl paraben | VX0425 | Spectrum |
| Trolamine | WE0546 | Spectrum |

The results of this experiment demonstrated the feasibility of preparing cosmetic creams using the modified whole grain oat flour in oil in water emulsions. The properties of the cosmetic creams were relatively insensitive to the type of water used (deionized versus sterile) or the amounts of methyl paraben and propyl paraben preservatives used.

### Example 8

### Batch Trials Optimized the pH of the Enzyme-Modified Whole Oat Slurry

To optimize the formulation of the enzyme-modified whole grain oat slurry for drum drying, the following experiment was conducted. In particular, this experiment was conducted to determine the amount of food-grade acid that adjusted the pH of the slurry to an optimal pH of 5.

Purified water was prepared by treating tap water with softening, reverse osmosis, carbon filtration, and micro-filtration systems. The purified water was heated to 50-55° C., and then 6.25 lbs. of oat flour was added and mixed with 41.7 lbs. of the purified water. The resulting oat slurry contained 15% oat flour by weight. 150 mL of 10% w/w food-grade phosphoric acid (CAS # 7664-38-2, Rhodia, Inc., Cranbury, N.J., USA) was added to the slurry, and the pH of the slurry was then measured. The process was repeated by adding an additional 150 mL of the 10% w/w food-grade phosphoric acid, and measuring the pH of the oat slurry. The process was repeated one additional time, and the pH of the oat slurry was measured after adding a total of 450 mL of 10% w/w food-grade phosphoric acid to the oat slurry. The results of the pH measurements are summarized in Table 9.

TABLE 9
pH of Oat Slurries after Addition of Phosphoric Acid.

| Cumulative amount of | |
|---|---|
| acid added (mL) | pH of oat slurry |
| 0 | 6.20 |
| 150 | 5.85 |
| 300 | 5.05 |
| 450 | 4.82 |

Because of the high buffering capacity of the whole grain oat flour slurry, 300 mL of 10% w/w food-grade phosphoric acid was required to adjust the pH of the oat slurry to the optimum pH of about 5. The results of this experiment demonstrated that adding a slightly higher amount of food-grade acid was necessary to adjust the pH of the oat slurry to pH=5.

### Example 9

### Batch Trials Optimized the Composition of the Enzyme-Modified Whole Oat Slurry for Larger Batches

To optimize the formulation of the enzyme-modified whole grain oat slurry for large batches, the following experiment was conducted. For each of two batches, purified water was prepared by treating tap water with softening, reverse osmosis, carbon filtration, and micro-filtration systems. The purified water was heated to 50-55° C., and then 6.25 lbs. of oat flour was added and mixed with 41.7 lbs. of the purified water for each batch. The resulting oat slurries contained 15% oat flour by weight. The pH of each batch's mixture was adjusted to 5.0±0.5 by adding 300 mL of 10% w/w food-grade phosphoric acid (CAS # 7664-38-2, Rhodia, Inc., Cranbury, N.J., USA). Cellulase enzyme (Enzyme Development Corp. #3-3526-000) was then added to the slurry in the amount of 1% of the weight of the oat flour. The oat slurry was then mildly agitated and maintained at a temperature of 50-55° C. for 30 minutes. Granulated potassium sorbate, a food preservative, was added to the oat slurries in the amount of 0.5% of the weight of the oat flour, and the oat slurries were mildly agitated at the same temperature for an additional thirty minutes. The oat slurries were then heated to 70°-80° C. for 5-10 minutes to gelatinize the starches and to inactivate the cellulose enzyme. The batches were then filtered through a 100 mesh screen to remove any remaining fiber from oat hulls in the oat slurry. Each batch was then processed through a sonolator to uniformly disperse the oat slurries. The sonolator used a dynamic pressure of 600-800 psig, a pump dial setting of 511, a setting of 213.5 RPM, and an acoustic intensity of 0.8-0.9.

After sonolation, a drum dryer was used to dry the whole grain oat slurries. The steam pressure and drum speed was set at 41 psig and 2 RPM, respectively. The drum clearance was 5 mm, and the drum speed readout was 1800, resulting in a product drying rate of about 1 lb/hr.

Overall, 9.6 lb. of enzyme-modified whole grain drum dried mass resulted from the original 12.5 lb. of whole grain oat flour, corresponding to a percent oat solids yield of 76.8%. Losses in the overall yield were due to residual losses from charging the processing equipment and moisture differences between the raw whole oat flour and the dried oat flakes and sheets.

The results of this experiment demonstrated the processing of larger batches of whole oat flour using the optimal formulation and process parameters defined in Example 8.

### Example 10

### Pilot Plant Trials Optimized the Formulation of the Enzyme-Modified Whole Oat Slurry for Large-Scale Production

To optimize the formulation of the enzyme-modified whole grain oat slurry for large-scale production, the following experiments were conducted. Three batches of enzyme-modified whole oat product were produced and tested. The three batches differed slightly in composition and process parameters, as described below. The ingredients combined to form the whole oat slurries for each batch using methods similar to those described on Example 9 are summarized below.

The oat slurry for each batch was maintained at 50° and mildly agitated for one hour. After 45 minutes of agitation, granulated potassium sorbate and rosemary extract were added to the slurries as food preservatives. For batch 3, an additional 500 mL of food-grade phosphoric acid was added to the oat slurry after the first 30 minutes of agitation to adjust the slurry to a pH of about 4.0, prior to adding the food preservatives after 45 minutes of agitation.

TABLE 10
Summary of Ingredients Used in Trial Batches of Enzyme-Modified
Oat Flours.

| | | Oat | | Cellulase | Potassium | Rosemary |
|---|---|---|---|---|---|---|
| Batch | Water | Flour | H₃PO₄ | Enzyme | sorbate | extract |
| 1 | 28 lb. | 12 lb. | 500 ml | 54.4 g | 27.2 g | 7.2 g |
| 2 | 28 lb. | 12 lb. | 500 ml | 54.4 g | 27.2 g | 7.2 g |
| 3 | 28.5 lb. | 12 lb. | 1000 ml | 54.4 g | 27.2 g | 7.2 g |
| | | | | (diluted in | | |
| | | | | 500 mL of | | |
| | | | | purified | | |
| | | | | water) | | |

For each of the three batches, purified water was prepared by treating tap water with softening, reverse osmosis, carbon filtration, and micro-filtration systems. The purified water was heated to 50° C., and then 500 ml of 10% w/w food-grade phosphoric acid (CAS # 7664-38-2, Rhodia, Inc., Cranbury, N.J., USA) was added to adjust the pH of the purified water to about 1.9. For batches 1 and 2, cellulase enzyme (#3-3526-000, Enzyme Development Corp.) was added in the amount of 1% of the weight of the oat flour to be added, followed by 12 lb. of whole grain oat flour. For batch 3, 12 lb. of whole oat flour was added to the mixture of water and acid, followed by the cellulase, which was diluted in an additional 500 mL of purified water.

After the completion of the heating and agitation, all batches were then filtered through a 100 mesh screen to remove any remaining fiber in the oat slurry. The three batches of oat slurry were then divided into smaller batches and processed using various methods, summarized in Table 11.

TABLE 11
Summary of Processes Used in Trial Batches
of Enzyme-Modified Oat Flours.

| | Initial | | | |
|---|---|---|---|---|
| | weight of | Emulsification | Drying | |
| Batch | slurry | method | Method | Comments |
| 1A | 20 lb. | homogenizer | Spray dryer | |
| 1B | 20 lb. | sonolator | Drum dryer | |
| 2A | 20 lb. | homogenizer | Drum dryer | |
| 2B | 20 lb. | sonolator | Spray dryer | 1.24 lb. of purified |
| | | | | water added after |
| | | | | sonolation |
| 3A | 20 lb. | sonolator | Spray dryer | |
| 3B | 10 lb. | none | none | slurry used for lotion |
| 3C | 10 lb. | none | none | slurry used for lotion |

Batches 1A and 2A were run through a homogenizer to uniformly disperse the enzyme-modified oat flour in the slurry, using pressures of 5000 psig and 6000 psig, respectively. Batches 1B, 2B, and 3A were all run through the sonolator to emulsify the oat flour slurries, using a dynamic pressure of 600-700 psig, a pump dial setting of 522, an RPM of 252, and an acoustic intensity of 0.8-1.0 for all three batches.

After running the batches of oat slurries through the sonolator or homogenizer, the oat slurries appeared to be uniformly dispersed with a light tan color throughout the batches. The viscosities of batches 2A and 2B were measured using a Bostwick consistometer after processing with the homogenizer or sonolator, respectively. The results of these measurements are summarized in Table 12.

TABLE 12
Viscosity Measurements of Emulsified Oat Slurries.

| | Emulsification | | Velocity |
|---|---|---|---|
| Batch | method | Temp (° C.) | (cm/s) |
| 2A | homogenizer | 45 | 0.90 |
| 2B | sonolator | 46 | 0.44 |

Batches 1A, 2B, and 3A were dried at 113° F. using a spray dryer using a lg/ext nozzle, a pump speed setting of 05, an air pressure of 27 psig, a furnace temperature of 590° F., an inlet air temperature of 340° F., and an outlet air temperature of 340° F. The enzyme-modified oat slurry atomized and formed fine and coarse powders. The fine powder was collected in the side chamber and the coarse powders (heavies) settled at the bottom of the spray dryer chamber. Batch 2B was too thick to pump to the spray dryer and 1.24 lbs. of water was added to the enzyme-modified oat slurry prior to spray drying.

Batches 1B and 2A were dried using a drum dryer. The steam pressure and drum speed was set at 42 psig and 0.65 revolutions per minute. Both batches formed thin dehydrated oat sheets on the dyer drum surface without burning or scorching on the drums.

The pH of batch 1 during agitation was measured every 15 minutes to determine any changes in the pH of the slurry during the enzymatic digestion of the oat flour. The results of these measurements, indicating that the pH of the slurry gradually increased from 4.1 to 5.2, are summarized in Table 13. The largest jump in pH occurred during the first 15 minutes of agitation.

TABLE 13
pH of Oat Slurry Batch 1 During Enzymatic Digestion.

| Time (min) | pH of slurry |
|---|---|
| 0 | 4.1 |
| 15 | 4.75 |
| 30 | 4.98 |
| 45 | 5.01 |
| 60 | 5.2 |

The pH of batch 3 during agitation was also measured every 15 minutes to determine any changes in the pH of the slurry during the enzymatic digestion of the oat flour. After the pH measurement at 30 minutes, 500 mL of food-grade phosphoric acid was added to the slurry. As a result, the oat flour slurry in batch 3 remained at about 4 for the last 30 minutes of the agitation process. The results of the pH measurements of batch 3 are summarized in Table 14.

TABLE 14
pH of Oat Slurry Batch 3 During Enzymatic Digestion.

| Time (min) | pH of slurry |
|---|---|
| 0 | 4.1 |
| 15 | 4.84 |
| 30 (before adding 500 ml H₃PO₄) | 5.25 |
| 45 | 3.94 |
| 60 | 4.06 |

The Differential Scanning Calorimetry (DSC) method (Ratnayake and Jackson, 2008) was used to determine the percent starch gelatinization of drum and spray dried enzyme-modified whole grain oat slurries. For the spray-dried samples, only the fines portion was tested. A 10 mg sample of each batch was mixed with about 55 mL of water in sealed DSC pans, and allowed to stand at room temperature for about 1 hour. The samples were then scanned at a rate of 10° C./min from 25° C. to 130° C. Degree of gelatinization was calculated as the ratio of enthalpic difference between the reference and sample to the enthalpy of the reference. For the DSC measurements of this experiment, unprocessed whole oat flour was used as the reference. The percent gelatinization measured for all of the batches that were dried using spray drying or drum drying are summarized in Table 15.

TABLE 15
DSC-Measured Gelatinization of Dried Enzyme-Modified Whole Oat
Products.

| | Emulsification | | Degree of |
|---|---|---|---|
| Batch | method | Enthalpy (J/g) | Gelatinization |
| Reference | Average native | 8.766 | 0% |
| | oat starch* | | |
| Control 1 | none | 2.864 | 67% |
| | (unprocessed | | |
| | whole oat flour) | | |
| Control 2 | none | 2.285 | 74% |
| | (unprocessed | | |
| | whole oat flour) | | |
| 1A | homogenizer | Spray dryer | 82% |
| 1B | sonolator | Drum dryer | 100% |
| 2A | homogenizer | Drum dryer | 100% |
| 3A | sonolator | Spray dryer | 81% |

*average of three cultivars

100% starch gelatinization occurred with drum drying of the enzyme-modified oat slurry, and starch gelatinization of about 81-82% occurred when the oat slurry was spray dried. The heating of the slurry during drum drying likely gelatinizes the starches in the enzyme-modified oat slurries.

The results of this experiment determined optimal formulation and process parameters for large-scale production of enzyme-modified whole grain oat slurries. An oat flour concentration of 30% by weight is likely the maximum that may be processed using the methods described above. The addition of the cellulase enzyme appeared to thin out the oat slurry rapidly when the enzyme was diluted in 500 mL of water prior to its addition to the slurry. Drum drying of the enzyme-modified oat slurry resulted in complete gelatinization of the starches in the slurry.

### Example 11

### Cosmetic Lotions Incorporating Modified Whole Grain Oat Slurry Were Prepared

To determine the feasibility of preparing cosmetic lotions containing a slurry of modified whole grain oat flour, the following experiment was conducted. Two different cosmetic creams were prepared using the oat flour slurries from batches 3B and 3C in Example 10, described above.

One cosmetic lotion formulation contained 10 lbs. of enzyme-modified oat slurry, 5 lbs. of high oleic sunflower oil, and 0.68 grams of an emulsifier mixture that included mono-diglycerides, guar gum, polysorbate 80, carrageenan, and dextrose. The second cosmetic lotion formulation contained 10 lb. of enzyme-modified oat slurry, 3 lbs. of high oleic sunflower oil, 68 grams of parodan, and 34 grams of Nielson Massy 505 (2×) Vanilla.

For both cosmetic lotions, the oat slurries were heated to a temperature of 70° C. After ten minutes at 70° C., the other ingredients were mixed with the oat slurries, yielding cosmetic lotions containing the enzyme-modified whole oat product as an ingredient.

The results of this experiment demonstrated the feasibility of producing cosmetic lotion formulations using the enzyme-modified whole oat slurries as a raw ingredient.

While the invention has been explained in relation to exemplary embodiments, it is to be understood that various modifications thereof will become apparent to those skilled in the art upon reading the description. Therefore, it is to be understood that the invention disclosed herein is intended to cover such modifications as fall within the scope of the appended claims.

### REFERENCE

1. Ratnayake, W. S. and Jackson, D. S. (2008). Journal of Food Science, Vol. 73(5), p. C356-C366.

What is claimed is:

1. A method of producing a modified whole grain oat flour, the method comprising:
a. contacting a fiber-digesting enzyme with a suspension comprising an amount of water and cleaned whole grain oat flour; and,
b. treating the suspension for a period of time sufficient to hydrolyze fiber particles such that a modified whole grain oat flour is formed.

2. The method of claim 1, wherein the modified whole grain oat flour consists of particles less than about 150 μm in diameter.

3. The method of claim 1, wherein the modified whole grain oat flour consists of particles less than about 44 μm in diameter.

4. The method of claim 1, wherein the at least one fiber-digesting enzyme comprises a cellulase.

5. The method of claim 1, wherein the method further comprises filtering the suspension after the fiber particles have been hydrolyzed.

6. The method of claim 1, wherein the modified whole grain oat flour comprises an amount of enzymatically-digested fiber particles.

7. The method of claim 1, wherein the method additionally comprises contacting at least one additional digestive enzyme selected from the group consisting of an amylase, a protease, and combinations thereof.

8. The method of claim 1, wherein the method further comprises drying the suspension after the fiber particles have been hydrolyzed.

9. The method of claim 1, wherein the suspension further comprises a food-grade acid.

10. The method of claim 1, wherein the method further comprises mixing the modified whole grain oat flour with other ingredients to form a whole oat-fortified food product.

11. The method of claim 1, wherein the method further comprises mixing the modified whole grain oat flour with other ingredients to form a whole oat-fortified personal care product.

12. The method of claim 1, wherein the method further comprises mixing the modified whole grain oat flour with other ingredients to form a pharmaceutical or dietary supplement product.

13. A method of producing a modified whole grain oat flour comprising an amount of enzymatically-digested fiber particles, the method comprising:
a. contacting an amount of water with an amount of food-grade acid to form a mixture;
b. contacting an amount of cleaned whole grain oat flour with the mixture to form a suspension;
c. contacting the suspension with an amount of fiber-digesting enzyme; and,
d. agitating the mixture for a period of time sufficient to hydrolyze fiber particles.

14. The method of claim 13, wherein the fiber-digesting enzyme comprises a cellulase.

15. The method of claim 13, wherein the method additionally comprises contacting the suspension with at least one additional digestive enzyme selected from the group consisting of an amylase, a protease, and combinations thereof.

16. The method of claim 13, wherein the pH of the suspension ranges between about 3.5 and about 6.5.

17. The method of claim 13, wherein the temperature of the suspension ranges between about 45° C. and about 75° C.

18. The method of claim 13, wherein the amount of cleaned whole grain oat flour in the suspension ranges between about 0.1% and about 50% by weight.

19. The method of claim 13, wherein the suspension is agitated for an amount of time ranging between about 30 minutes and about 2 hours.

20. The method of claim 13, wherein the mixture is subjected to homogenization or sonolation after the fiber has been hydrolyzed.

21. A modified whole grain oat flour, comprising an amount of enzymatically-digested fiber particles.

22. The modified whole grain oat flour of claim 21, wherein the flour comprises particles no larger than about 150 μm in size.

23. The modified whole grain oat flour of claim 21, wherein the flour comprises particles no larger than about 44 μm in size.

24. The modified whole grain oat flour of claim 21, wherein the modified whole grain oat flour is suspended in an amount of water ranging between about 50% and about 99.9% water by weight.

25. The modified whole grain oat flour of claim 24, wherein the pH of the suspension ranges between about 3 and about 6.

26. A whole oat-fortified product comprising modified whole grain oat flour comprising enzymatically-digested fiber particles.

27. The whole oat-fortified product of claim 26, wherein the modified whole grain oat flour further comprises enzymatically-digested and denatured protein particles.

28. The whole oat-fortified product of claim 26, wherein the whole oat-fortified product is selected from the group comprising topical formulation, food product, beverage, pharmaceutical formulation, and dietary supplement formulation.
